(19) United States
(12) Patent Application Publication
(10) Pub. No.: US 2026/0111555 A1
(43) Pub. Date: Apr. 23, 2026

(54) METHOD AND DEVICE FOR SECURE BOOTING OF ELECTRONIC CONTROL UNIT THROUGH MUTUAL AUTHENTICATION

(71) Applicant: FESCARO Co., Ltd., Suwon-si (KR)

(72) Inventors: Seokmin HONG, Suwonsi (KR); Heeguk YANG, Suwonsi (KR); Kyungyeon PARK, Suwonsi (KR); Donghyeon KIM, Suwonsi (KR); Taehyun KIM, Suwonsi (KR)

(21) Appl. No.: 19/251,905

(22) Filed: Jun. 27, 2025

(30) Foreign Application Priority Data
Oct. 21, 2024 (KR) 10-2024-0144020
Oct. 21, 2024 (KR) 10-2024-0144021
Dec. 30, 2024 (KR) 10-2024-0201482
Dec. 31, 2024 (KR) 10-2024-0202345

(51) Int. Cl. G06F 21/57; G06F 21/44; G06F 21/64

(52) U.S. Cl. CPC G06F 21/575; G06F 21/445; G06F 21/64

(57) ABSTRACT

Provided are a method and device for secure booting of an electronic control unit through mutual authentication, wherein the method includes: performing first integrity verification on a secure boot loader and a software security module in response to receiving a boot signal of a micro-controller unit (MCU) included in an electronic control unit within a vehicle; performing mutual authentication between the secure boot loader and the software security module, on the basis of a result of the first integrity verification; and performing second integrity verification on first host firmware on the basis of a result of the mutual authentication above.

### CROSS-REFERENCE TO RELATED APPLICATION

This application is based on and claims priority under 35 USC § 119 to Korean Patent Application No. 10-2024-0144020, filed on Oct. 21, 2024, Korean Patent Application No. 10-2024-0144021, filed on Oct. 21, 2024, Korean Patent Application No. 10-2024-0201482, filed on Dec. 30, 2024, and Korean Patent Application No. 10-2024-0202345, filed on Dec. 31, 2024 in the Korean Intellectual Property Office, the disclosure of which is incorporated by reference herein in its entirety.

### BACKGROUND

### 1. Field

The disclosure relates to a method and device for secure booting of an electronic control unit through mutual authentication.

### 2. Description of the Related Art

In general, with the rapid development of electronic control technology, various types of devices, which operate by mechanical methods even in vehicles, have been driven by electrical methods for reasons such as driver convenience and driving safety, and automobile systems have gradually become advanced and state-of-the-art.

In addition to electronic devices for driving, vehicles may be provided with electronic devices that perform various safety and security functions for the safety of drivers and passengers. Here, a plurality of electronic devices may operate organically with each other. The electronic devices may also be connected to external networks. Recently, as various electronic devices are installed in vehicles, a large number of electronic control units (ECUs) for controlling the electronic devices have been installed in vehicles.

In addition, to prevent security threats to the electronic control units, security modules may be mounted on the vehicles. There are hardware security modules (HSMs) as the security modules mounted on the vehicles, but the HSMs additionally demand separate physical components, and thus, manufacturing costs of the vehicles increase.

Accordingly, there is a need to develop technology that may enhance security by implementing security modules as software and technology that implements security modules providing security function as software.

The foregoing background art is technical information that the inventor has possessed for derivation of the disclosure or has acquired during the derivation process of the disclosure, and may not be necessarily known art disclosed to the general public prior to the filing of the disclosure.

### SUMMARY

The disclosure provides a method and device for secure booting of an electronic control unit (ECU) through mutual authentication. The problems to be solved by the disclosure are not limited to the problems mentioned above, and other problems and advantages of the disclosure that are not mentioned may be understood by the following description and more clearly understood by embodiments. In addition, it will be appreciated that the problems and advantages to be solved by the disclosure may be implemented by means and combinations thereof defined in claims.

As a technical means for solving the above-described technical problem, a first aspect of the disclosure may provide a method for secure booting of an electronic control unit through mutual authentication including performing first integrity verification on a secure boot loader and a software security module in response to receiving a boot signal of a micro-controller unit (MCU) included in an electronic control unit within a vehicle, performing mutual authentication between the secure boot loader and the software security module, on the basis of a result of the first integrity verification, and performing second integrity verification on first host firmware on the basis of a result of the mutual authentication above.

In the first aspect, the performing the mutual authentication may include: generating a first authentication pattern by using the secure boot loader; generating a second authentication pattern by using the software security module; and performing the mutual authentication by comparing the first authentication pattern and the second authentication pattern.

In the first aspect, the generating the first authentication pattern and the second authentication pattern may include generating the first authentication pattern and the second authentication pattern by using an authentication number included in the secure boot loader.

In the first aspect, the method may further include, in a case where the first authentication pattern and the second authentication pattern are not equal to each other, determining that the mutual authentication fails and rebooting the secure boot loader or restricting execution of the software security module.

In the first aspect, the method may further include executing a protection mode restricting access to a secure memory area within the MCU, in response to receiving the boot signal, wherein the secure memory area includes at least one of the secure boot loader, the software security module, and a partial area of read only memory (RAM), data memory, and program memory used by the software security module.

In the first aspect, the method may further include switching from the protection mode to a normal mode in response to the second integrity verification being successful.

In the first aspect, the performing the first integrity verification may include: performing 1^{st}-1 integrity verification which is self-integrity verification on the secure boot loader; and performing 1^{st}-2 integrity verification on the software security module on the basis of a result of the self-integrity verification.

In the first aspect, the method may further include performing third integrity verification on second host firmware on the basis of a result of the second integrity verification.

In the first aspect, the software security module may include security function firmware implemented as separate firmware from the first host firmware and the secure boot loader within the program memory within the MCU.

In the first aspect, the secure boot loader may include firmware arranged at a start address when the program memory within the MCU is booted.

A second aspect of the disclosure may provide a device for secure booting of an electronic control unit through mutual authentication including: a secure boot loader; a software security module; and at least one piece of host firmware, wherein the secure boot loader performs first integrity verification on the secure boot loader and the software security module in response to receiving a boot signal of the MCU, performs mutual authentication between the secure boot loader and the software security module on the basis of a result of the first integrity verification, and performs second integrity verification on first host firmware on the basis of a result of the mutual authentication.

A third aspect of the disclosure may provide a computer-readable recording medium having recorded thereon a program for causing a computer to execute the method according to the first aspect.

In addition, another method for implementing the disclosure, another system, and a computer-readable recording medium having stored therein a program for executing the method may be further provided.

Other aspects, features and advantages other than those described above will become apparent from the following drawings, claims and detailed description of the disclosure.

### BRIEF DESCRIPTION OF THE DRAWINGS

The following drawings attached to the description illustrate embodiments and make the spirit of the disclosure to be further understood together with the detailed description of the disclosure described below, and thus, the disclosure should not be construed as being limited to only the matters described in the drawings:

FIG. 1 is an example diagram illustrating a structure of a micro-controller unit (MCU) of an electronic control unit (ECU) within a vehicle, according to an embodiment;

FIG. 2 is an example diagram illustrating a secure memory area included in an MCU within a vehicle, according to an embodiment;

FIG. 3 is an example diagram illustrating a structure of a program memory within an MCU including a software security module implemented in a firmware form, according to an embodiment;

FIG. 4 is an example diagram illustrating a structure of a program memory within an MCU including a software security module implemented in a library form, according to an embodiment;

FIG. 5 is an example diagram illustrating a method of performing mutual authentication between a software security module and secure boot loader by using an authentication pattern, according to an embodiment;

FIG. 6 is a flowchart illustrating a method for secure booting of an ECU through mutual authentication, according to an embodiment;

FIG. 7 is a flowchart illustrating a method of executing host firmware through integrity verification, according to an embodiment;

FIG. 8 is a flowchart illustrating a method for secure booting of an ECU using a protection mode and a normal mode, according to an embodiment;

FIG. 9 is an example diagram illustrating a structure of a program memory within an MCU having installed therein a software security module including a crypto function table, according to an embodiment;

FIG. 10 is an example diagram illustrating a structure of a program memory within an MCU having installed therein host firmware including a security API call code, according to an embodiment;

FIG. 11 is an example diagram illustrating a structure of a program memory within an MCU in which a security API is implemented in a library form within host firmware, according to an embodiment;

FIG. 12 is an example diagram illustrating a method of providing a result value in response to a request for executing a security function of host firmware, according to an embodiment;

FIG. 13 is a flowchart illustrating a method of executing a security function by using a software security module including a crypto function table, according to an embodiment;

FIG. 14 is a flowchart illustrating a method by which a software security module provides a result value in response to a request for executing a security function of host firmware, according to an embodiment;

FIG. 15 is an example diagram illustrating a structure of a program memory within an MCU including a software security module implemented in a firmware form and including a security API, and a secure boot loader, according to an embodiment;

FIG. 16 is a flowchart illustrating a method of booting an ECU through mutual authentication and executing a security function by using a software security module including a crypto function table, according to one embodiment;

FIG. 17 is an example diagram illustrating a structure of an ECU within a vehicle, according to an embodiment;

FIG. 18 is an example view illustrating a method of building and verifying a software security module, according to an embodiment; and

FIG. 19 is an example view illustrating a structure in which a software security module provides a result value in response to a request for executing a security function of host firmware, according to an embodiment.

### DETAILED DESCRIPTION

Advantages and features of the disclosure, and methods of achieving the same will become apparent with reference to embodiments described in detail in conjunction with the accompanying drawings. However, it should be understood that the disclosure is not limited to embodiments presented below, but may be implemented in various different forms, and includes all modifications, equivalents, and alternatives included in the spirit and scope of the disclosure. The embodiments presented below are provided to ensure that the disclosure is complete and to fully inform those skilled in the art of the scope of the disclosure. When describing the disclosure, the detailed description of related known arts, which may obscure the subject matter of the disclosure, will be omitted.

Terms used herein are only used to describe particular embodiments, and are not intended to limit the disclosure. The singular forms are intended to include the plural forms as well, unless the context clearly indicates otherwise. It should be understood that the terms “comprises,” “comprising,” “have,” and/or “having,” when used herein, specify the presence of stated features, integers, steps, operations, elements, components, or combinations thereof, but do not preclude the presence or addition of one or more other features, integers, steps, operations, elements, components, or combinations thereof.

Some of the embodiments may be represented by functional block components and various processing operations. Some or all of the functional blocks may be implemented as various numbers of hardware and/or software components that execute particular functions. For example, the functional blocks of the disclosure may be implemented by one or more microprocessors or implemented by circuit components for certain functions. In addition, for example, the functional blocks of the disclosure may be implemented in various programming or scripting languages. The functional blocks may be implemented as algorithms executed on one or more processors. In addition, the disclosure may employ the related art for electronic environment setup, signal processing, and/or data processing. Terms such as “mechanism”, “element”, “means”, and “component” may be broadly used and are not limited to mechanical and physical components.

In addition, connection lines or connection members between the components shown in the drawings merely illustrate examples of functional connections and/or physical or circuit connections. In an actual apparatus, connections between components may be represented by various replaceable or additional functional connections, physical connections, or circuit connections.

A vehicle provided in the disclosure may be a means of transportation that moves by moving wheels by using artificial power. The disclosure does not limit a type and shape of the vehicle, and the vehicle of the disclosure may include any means of transportation that may implement a method for secure booting of an ECU through mutual authentication, according to the disclosure. The vehicle of the present disclosure may include a connected car capable of communicating with the outside, but may also include a non-connected car.

Hereinafter, the disclosure is described in detail with reference to the accompanying drawings.

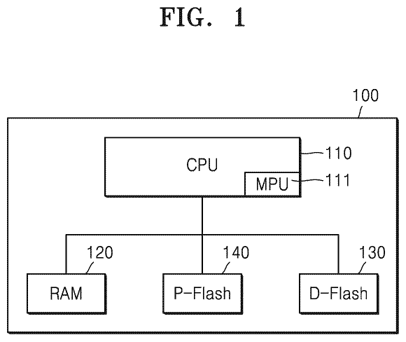

FIG. 1 is an example diagram illustrating a structure of a micro-controller unit (MCU) of an electronic control unit (ECU) within a vehicle, according to an embodiment.

Referring to FIG. 1, a vehicle (not shown) may include a plurality of ECUs (not shown).

The ECUs may refer to core units that electronically control and manage various functions of the vehicle, and may control various types of systems of the vehicle, such as an engine control system, a transmission control system, and a brake control system. In some embodiments, the ECUs within the vehicle may communicate with each other through controller area network (CAN) communication.

In some embodiments, an ECU may include at least one micro-controller unit (MCU) 100.

The MCU 100 may perform a logical operation needed for the ECU to perform a role. In an embodiment, the MCU 100 included in an ECU may receive data from sensors to calculate a fuel injection amount and determine an appropriate ignition timing.

The MCU 100 may include a central processing unit (CPU) 110, random access memory (RAM)) 120, D-Flash (data memory) 130, and P-Flash (program memory) 140, but is not limited thereto.

The CPU 110 may refer to a core computational unit that interprets a program and executes an instruction, within the MCU 100, and may sequentially read a program code stored in the program memory 140, and interpret and execute the instruction.

For example, the CPU 110 may include a memory protection unit (MPU) 111. The MPU 111 may protect a memory area within the MCU 100. For example, the MPU 111 may prevent data in the memory area, which is set as a secure memory area, from being read and written inside/outside the ECU. In some embodiments, the MPU 111 may set access rights to memories within the MCU 100.

In an embodiment, the MPU 111 may protect the memory area used by a software security module, which is set as the secure memory area.

The RAM 120 may refer to a volatile memory that retains data only when power is turned on, and may temporarily store data while the MCU 100 executes a program.

In an embodiment, the RAM 120 may store data in real time during internal processing of a security solution within the vehicle. In another embodiment, the RAM 120 may process security data stored in a secure storage.

The program memory 140 may refer to a nonvolatile memory that retains data even when power is turned off, and may store firmware such as an execution code of the ECU. The CPU 110 may perform a computation by using the execution code stored in the program memory 140.

For example, the program memory 140 may store at least one piece of host firmware.

In an embodiment, the program memory 140 may store application software (ASW). The ASW may correspond to software that performs a role assigned to the ECU. For example, the ASW may perform a runtime tuning protection (RTP) function for preventing manipulation of software.

In another embodiment, the program memory 140 may store a flash boot loader (FBL). The FBL may update the ASW. In some embodiments, the FBL may change execution of software from the ASW to the FBL when updating the ASW. In some embodiments, the FBL may verify integrity of the ASW.

In some embodiments, the program memory 140 may store a software security module. The software security module may execute a security function requested by the host firmware.

The data memory 130 may refer to a nonvolatile memory that retains data even when the power is turned off, and unlike the program memory 140, may freely read data and write data inside/outside of the ECU. Accordingly, the data memory 130 may store set values of the ECU, which are not frequently changed. In some embodiments, the data memory 130 may store security data such as an encryption key and a message authentication code.

In an embodiment, the data memory 130 may correspond to electrically erasable programmable ROM (EEPROM). The EEPROM may refer to a non-volatile memory (NVM) which data may written in and erased from, may retain data even when the power is turned off and thus may store the set values and/or the security data of the ECU.

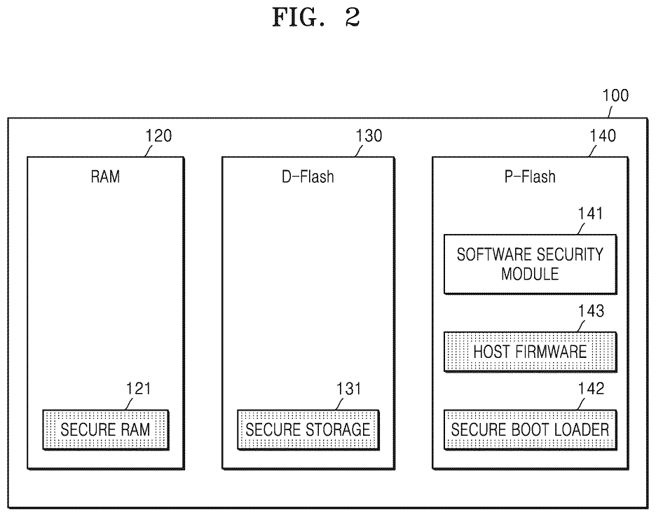

FIG. 2 is an example diagram illustrating a secure memory area included in an MCU within a vehicle, according to an embodiment.

Referring to FIG. 2, an MCU 100 may include RAM 120, D-Flash (data memory) 130, and P-Flash (program memory) 140, but is not limited thereto. The RAM 120 may include secure RAM 121, and the D-FLASH 130 may include a secure storage 131. In some embodiments, the program memory 140 may include a software security module 141, host firmware 143, and secure boot loader(SBL) 142.

A memory within the MCU 100 may include a secure memory area and a normal memory area.

The secure memory area may refer to a memory area to which access from the inside/outside of the MCU 100 is restricted. A protection mode may refer to a mode in which an operation is performed in the secure memory area, and in the protection mode, access to data stored in the secure memory area may be restricted. In some embodiments, a normal mode may refer to a mode in which an operation is performed in the normal memory area, and even in the normal mode, access to data stored in the secure memory area may be restricted.

For example, the secure memory area may include the secure RAM 121 of the RAM 120. The secure RAM 121 may refer to a memory area that stores security-sensitive data such as an encryption key stored in the RAM 120.

In an embodiment, the secure RAM 121 may be arranged from −16 KB of the highest address of the RAM 120.

In some embodiments, the secure memory area may include the secure storage 131 of the data memory 130. The secure storage 131 may refer to a memory area that stores security data such as an encryption key, a certificate, integrity verification data, and a security log.

In some embodiments, the secure storage 131 may be allocated to one area of the data memory 130. In some embodiments, security data stored in the secure storage 131 may be encrypted to ensure confidentiality and integrity. In some embodiments, the secure storage 131 may be protected by the MPU 111 of FIG. 1.

In an embodiment, the secure storage 131 may be arranged from −32 KB of the highest address of the data memory 130.

In an embodiment, referring to FIG. 2, the secure memory area may include the software security module 141 and the SBL 142 of the program memory 140. The host firmware included in the program memory 140 may be included in the normal memory area rather than the secure memory area. Unlike a secure memory area, the host firmware, which is the normal memory area, may be accessed from the inside/outside of the ECU and thus may be read/written.

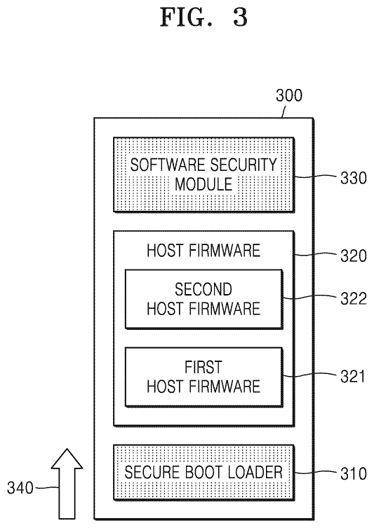

Hereinafter, an MCU including a software security module is described in detail with reference to FIGS. 3 to 14.

FIG. 3 is an example diagram illustrating a structure of a program memory within an MCU including a software security module 330 implemented in a firmware form, according to an embodiment.

Referring to FIG. 3, an MCU (not shown) of an ECU (not shown) within a vehicle may include a program memory 300. In some embodiments, the program memory 300 may refer to the same memory as the program memory 140 of FIGS. 1 and 2.

The program memory 300 may include a SBL 310, host firmware 320, and the software security module 330, but is not limited thereto.

The SBL 310 may verify integrity of the SBL 310, the host firmware 320, and the software security module 330 included in the program memory 300 when the MCU is booted.

In some embodiments, the SBL 310 may perform mutual authentication with the software security module 330 to enhance security. In some embodiments, the SBL 310 may perform the mutual authentication by comparing an authentication pattern generated by the SBL 310 with an authentication pattern generated by the software security module 330.

In the related art, when the MCU does not support boot read only memory (ROM), an FBL, which is the host firmware 320, needs to verify integrity thereof after the MCU is booted. Accordingly, the FBL having unverified integrity needs to verify the FBL and thus has high vulnerability to security.

However, the program memory 300 of the disclosure may improve security by performing integrity verification on the host firmware 320 within the program memory 300, such as the FBL, by using the software security module 330.

The host firmware 320 may refer to core software executed for an actual ECU to operate. In some embodiments, the host firmware 320 may include a plurality of pieces of software.

For example, the host firmware 320 may include first host firmware 321 and second host firmware 322, but is not limited thereto. In some embodiments, the first host firmware 321 may correspond to the FBL. In some embodiments, the second host firmware 322 may correspond to ASW.

The software security module 330 may refer to software that may perform a security function for protecting the ECU.

For example, the security function may include secure boot, RTP, a secure storage, memory protection, secure debug, cryptographic operations, and random number generation, but are not limited thereto.

In the related art, a security module may refer to hardware and may be implemented as a separate chip from the MCU. In the case of a hardware security module, an additional cost incurs for installation of a separate chip. In some embodiments, in the case of a vehicle that does not have a hardware security module installed therein when the vehicle is released, a hardware security module needs to be separately installed to implement the security function.

However, the program memory 300 of the disclosure may provide root of trust (RoT), i.e., a highest security trust point, by using a security module implemented as software.

In some embodiments, the software security module 330 may improve security of the ECU through mutual authentication. In some embodiments, the software security module 330 may receive, from the SBL 310, an instruction for generating an authentication pattern and generate an authentication pattern by using an authentication number included in the SBL 310. The software security module 330 may also perform mutual authentication on the basis of generating an authentication pattern, comparing the authentication pattern generated by the software security module 330 with the authentication pattern generated by the SBL 310, and determining whether or not the authentication patterns are the same as each other.

The program memory 300 may execute firmware according to a memory arrangement order 340 in response to receiving a boot signal of the MCU.

For example, the SBL 310 may be arranged at a start address of the program memory 300 to operate first in response to the MCU receiving the boot signal.

In some embodiments, the software security module 330 may be arranged at an end address of the program memory 300. In an embodiment, the software security module 330 may be arranged from −64 KB of the highest address of the program memory 300.

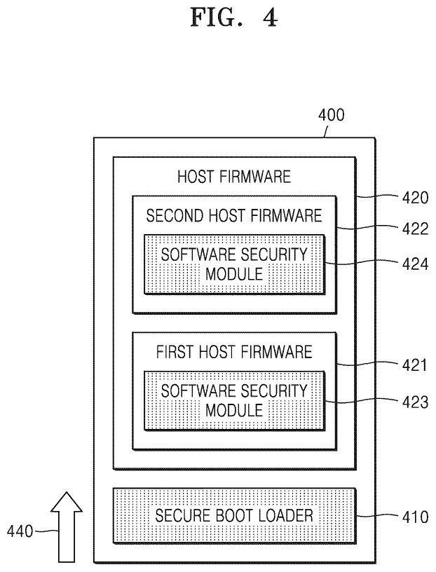

FIG. 4 is an example diagram illustrating a structure of a program memory within an MCU including a software security module implemented in a library form, according to an embodiment.

Referring to FIG. 4, an MCU (not shown) of an ECU (not shown) within a vehicle may include a program memory 400. In some embodiments, the program memory 400 may refer to the same memory as the program memory 140 of FIGS. 1 and 2.

The program memory 400 may include an SBL 410, host firmware 420, and software security modules 423 and 424, but is not limited thereto.

The SBL 410 may refer to firmware that verifies integrity of the SBL 410, the host firmware 420, and the software security modules 423 and 424 included in the program memory 400, and may refer to the same firmware as the SBL 310 of FIG. 3.

The host firmware 420 may refer to core software executed for an actual ECU to operate, and may refer to the same firmware as the host firmware 320 of FIG. 3.

In some embodiments, the host firmware 420 may include a plurality of pieces of software. In some embodiments, the host firmware 420 may include first host firmware 421 and second host firmware 422, the first host firmware 421 may correspond to an FBL, and the second host firmware 422 may correspond to ASW.

The software security modules 423 and 424 may refer to software that may perform a security function for protecting the ECU.

Unlike the software security module 330 of FIG. 3 implemented in the firmware form, the software security modules 423 and 424 may be implemented in library forms inside the host firmware 420.

For example, the software security modules 423 and 424 may be respectively included in the first host firmware 421 and the second host firmware 422 in a library form.

In the case of the software security modules 423 and 424 implemented in the library forms, in the case where only contents of libraries are modified when bugs are fixed or functions are added, the modified contents may be automatically applied to the host firmware 420 including the software security modules 423 and 424, and thus, the program memory 400 may have high maintainability. However, unlike a software security module implemented in a firmware form, the software security modules 423 and 424 implemented in the library forms may be implemented as secure memory areas within the host firmware 420 that is separated into a normal memory area, and thus, may have relatively low security.

In some embodiments, the program memory 400 may execute firmware according to a memory arrangement order 440 in response to receiving a boot signal of the MCU.

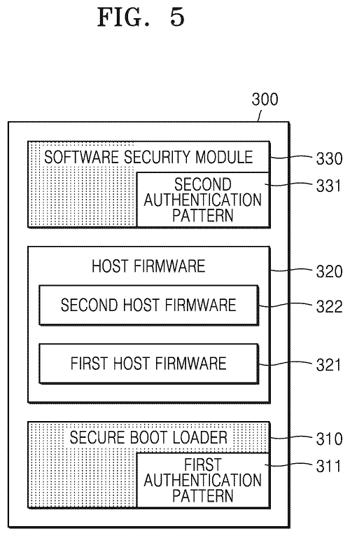

FIG. 5 is an example diagram illustrating a method of performing mutual authentication between a software security module and an SBL by using an authentication pattern, according to an embodiment.

Referring to FIG. 5, a program memory 300 may include an SBL 310, host firmware 320, and a software security module 330. In some embodiments, the host firmware 320 may include first host firmware 321 and second host firmware 322, the first host firmware 321 may correspond to an FBL, and the second host firmware 322 may correspond to ASW.

The SBL 310 of the program memory 300 may perform mutual authentication. In some embodiments, the mutual authentication may indicate that the software security module 330 and the SBL 310 perform integrity verification with each other.

The SBL 310 may generate a first authentication pattern 311 by using an authentication number of a preset memory area of the SBL 310.

In an embodiment, the SBL 310 may generate the first authentication pattern 311 from the authentication number by using an authentication pattern generation algorithm pre-stored in the SBL 310. In some embodiments, the authentication pattern generation algorithm may be stored in the SBL 310 from the time at which an ECU is released.

The software security module 330 may generate a second authentication pattern 331 by using the authentication number of the preset memory area of the SBL 310.

In an embodiment, the software security module 330 may generate the second authentication pattern 331 from the authentication number stored in the SBL 310 by using the authentication pattern generation algorithm pre-stored in the software security module 330. In some embodiments, the authentication pattern generation algorithm may be stored in the software security module 330 from the time at which the ECU is released.

In an embodiment, the authentication pattern generation algorithm may be protected through an MPU included in the MCU. In another embodiment, the authentication pattern generation algorithm may be protected through a secure debug function that is one of security functions provided by the software security module 330. Accordingly, the authentication pattern generation algorithm may be prevented from being manipulated from the outside.

The SBL 310 may perform mutual authentication by receiving, from the software security module 330, a result of comparing the first authentication pattern 311 generated through the SBL 310 with the second authentication pattern 331 generated through the software security module 330.

For example, the SBL 310 may perform the mutual authentication through a result of determining whether or not the first authentication pattern 311 and the second authentication pattern 331 match each other, which is received from the software security module 330. In the case where the first authentication pattern 311 and the second authentication pattern 331 match each other, the SBL 310 may determine that the mutual authentication is successful. In some embodiments, in the case where the first authentication pattern 311 and the second authentication pattern 331 do not match each other, the SBL 310 may determine that the mutual authentication fails.

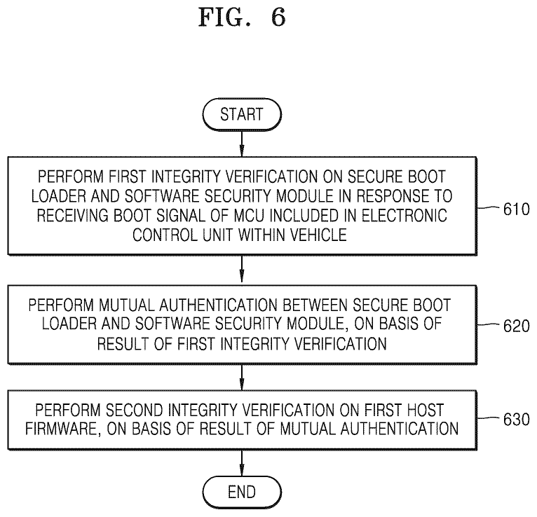

FIG. 6 is a flowchart illustrating a method for secure booting of an ECU through mutual authentication, according to an embodiment.

Referring to FIG. 6, the method for secure booting of an ECU through mutual authentication may include operations processed in a time series in the program memory 140 illustrated in FIGS. 1 and 2. Therefore, even in the case where the above description of the program memory 140 illustrated in FIGS. 1 and 2 is omitted, the above description may also be applied to the method for secure booting of an ECU through mutual authentication, illustrated in FIG. 6.

In operation 610, an SBL within a program memory may perform first integrity verification on the SBL and a software security module in response to receiving a boot signal of an MCU included in an ECU within a vehicle.

For example, the SBL may first perform 1^{st}-1 integrity verification on the SBL after receiving the boot signal of the MCU.

In some embodiments, the SBL may perform 1^{st}-2 integrity verification on the software security module on the basis of the result of the 1^{st}-1 integrity verification. In some embodiments, in the case where the 1^{st}-1 integrity verification is successful, the SBL may perform the 1^{st}-2 integrity verification on the software security module.

In operation 620, the SBL within the program memory may perform mutual authentication between the SBL and the software security module, on the basis of the result of first integrity verification.

For example, in the case where both the 1^{st}-1 integrity verification on the SBL and the 1^{st}-2 integrity verification on the software security module are successful, the SBL may perform the mutual authentication between the SBL and the software security module.

In an embodiment, the SBL may perform the mutual authentication by comparing a first authentication pattern generated by using an authentication number stored in the SBL with a second authentication pattern generated by the software security module by using an authentication number stored in the SBL.

In operation 630, the SBL within the program memory may perform second integrity verification on first host firmware on the basis of the result of the mutual authentication.

In some embodiments, the first host firmware may refer to an FBL.

For example, in the case where the first authentication pattern generated by the SBL matches the second authentication pattern generated by the software security module, the SBL may determine that the mutual authentication is successful and perform second integrity verification on the first host firmware.

Accordingly, the MCU may provide root of trust (RoT), i.e., a highest security trust point.

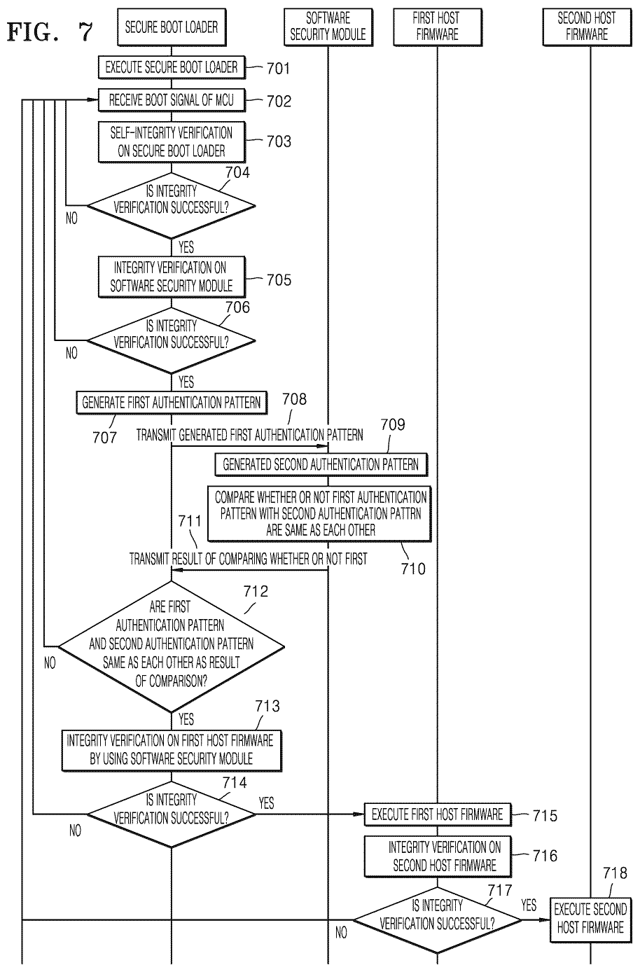

FIG. 7 is a flowchart illustrating a method of executing host firmware through integrity verification, according to an embodiment.

Referring to FIG. 7, a method of executing host firmware through integrity verification may include operations processed in a time series in the program memory 140 illustrated in FIGS. 1 and 2. Therefore, even in the case where the above description of the program memory 140 illustrated in FIGS. 1 and 2 is omitted, the above description may also be applied to the method of executing the host firmware through the integrity verification, illustrated in FIG. 7.

In operations 701 and 702, an SBL may be executed by receiving a boot signal of an MCU.

In operation 703, the SBL may perform self-integrity verification on the SBL.

For example, the SBL may be arranged at a start address of a program memory to first perform integrity verification on the SBL after the MCU is booted.

In operation 704, the SBL may determine whether or not the integrity verification on the SBL is successful.

In the case where the integrity verification fails, in operation 702, the SBL may be re-executed.

In the case where the integrity verification is successful, in operation 705, the SBL may perform integrity verification on a software security module.

In operation 706, the SBL may determine whether or not the integrity verification on the software security module is successful.

In the case where the integrity verification fails, in operation 702, the SBL may be re-executed.

In the case where the integrity verification is successful, in operation 707, the SBL may generate a first authentication pattern.

For example, the SBL may generate the first authentication pattern by using an authentication number stored in a partial area of the SBL. In some embodiments, the SBL may generate the first authentication pattern from the authentication number by using an authentication pattern generation algorithm stored in the SBL.

In operation 708, the SBL may transmit the generated first authentication pattern to the software security module.

In operation 709, the software security module may generate a second authentication pattern in response to receiving the first authentication pattern from the SBL.

For example, the software security module may generate the second authentication pattern by using the authentication number stored in the partial area of the SBL. In some embodiments, the software security module may generate the second authentication pattern from the authentication number by using the authentication pattern generation algorithm stored in the software security module.

In operation 710, the software security module may compare whether or not the first authentication pattern and the second authentication pattern are the same as each other.

In operation 711, the software security module may transmit, to the SBL, the result of comparing whether or not the first authentication pattern and the second authentication pattern are the same as each other.

In operation 712, the SBL may perform mutual authentication by determining whether or not the first authentication pattern and the second authentication pattern are the same as each other, through the result of comparing whether or not the first authentication pattern and the second authentication pattern are the same as each other, which is received from the software security module.

In the case where the first authentication pattern and the second authentication pattern are not the same as each other, in operation 702, the SBL may be re-executed.

In another embodiment, in the case where the first authentication pattern and the second authentication pattern are not the same as each other, the SBL may limit the execution of the software security module.

In the case where the first authentication pattern and the second authentication pattern are the same as each other, in operation 713, the SBL may perform integrity verification on first host firmware by using the software security module.

In operation 714, the SBL may determine whether or not the integrity verification on the first host firmware is successful.

In the case where the integrity verification fails, in operation 702, the SBL may be re-executed.

In the case where the integrity verification is successful, in operation 715, the first host firmware may be executed.

In some embodiments, the first host firmware may correspond to an FBL.

In operation 716, the first host firmware may perform integrity verification on second host firmware by using the software security module.

In operation 717, the first host firmware may determine whether or not the integrity verification on the second host firmware is successful.

In the case where the integrity verification fails, in operation 702, the SBL may be re-executed.

In the case where the integrity verification is successful, in operation 718, the second host firmware may be executed.

In some embodiments, the second host firmware may correspond to ASW.

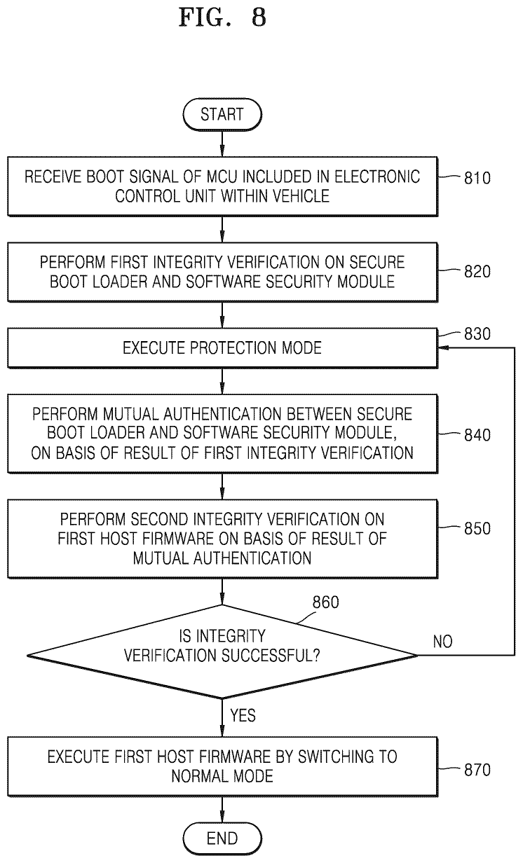

FIG. 8 is a flowchart illustrating a method for secure booting of an ECU using a protection mode and a normal mode, according to an embodiment.

Referring to FIG. 8, the method for secure booting of the ECU using the protection mode and the normal mode may include operations processed in a time series in the program memory 140 illustrated in FIGS. 1 and 2. Therefore, even in the case where the above description of the program memory 140 illustrated in FIGS. 1 and 2 is omitted, the above description may also be applied to the method for secure booting of the ECU using the protection mode and the normal mode, illustrated in FIG. 8.

In operation 810, an SBL may receive a boot signal of an MCU included in an ECU within a vehicle.

In operation 820, the SBL may perform first integrity verification on the SBL and a software security module.

For example, the SBL may first perform 1^{st}-1 integrity verification on the SBL after receiving the boot signal of the MCU.

In some embodiments, the SBL may perform 1^{st}-2 integrity verification on the software security module on the basis of the result of the 1^{st}-1 integrity verification.

In operation 830, a protection mode may be executed on the basis of the result of the first integrity verification.

For example, in the case where both the 1^{st}-1 integrity verification on the SBL and the 1^{st}-2 integrity verification on the software security module are successful, the SBL may execute the protection mode.

In some embodiments, the protection mode may refer to a mode for restricting access to a secure memory area within the MCU. In some embodiments, in the case where the protection mode is executed, reading/writing with respect to the secure memory area from the inside/outside of the ECU may be restricted.

In some embodiments, the secure memory area may include a software security module and an SBL of a program memory. In some embodiments, the secure memory area may include a secure storage of a data memory. In some embodiments, the secure memory area may include secure RAM of RAM.

In operation 840, the SBL may perform mutual authentication between the SBL and the software security module, on the basis of the result of the first integrity verification.

For example, in the case where the first integrity verification is successful, the SBL may perform the mutual authentication between the SBL and the software security module.

For example, the SBL may perform the mutual authentication by comparing a first authentication pattern generated by using the SBL with a second authentication pattern generated by using the software security module. In some embodiments, the first authentication pattern and the second authentication pattern may be generated on the basis of an authentication number stored in a partial area of the SBL.

In operation 850, the SBL may perform second integrity verification on first host firmware on the basis of the result of the mutual authentication.

For example, in the case where the mutual authentication is successful, i.e., in the case where the first authentication pattern and the second authentication pattern are the same as each other, the SBL may perform the second integrity verification on the first host firmware.

In some embodiments, the first host firmware may correspond to an FBL.

In operation 860, the SBL may determine whether or not the second integrity verification on the first host firmware is successful.

In the case where the integrity verification fails, in operation 830, the SBL may continue to execute the protection mode that is previously executed.

In the case where the integrity verification is successful, in operation 870, the SBL may execute the first host firmware by switching the protection mode to a normal mode.

In some embodiments, the normal mode may refer to a mode that enables access to a normal memory area within the MCU. In some embodiments, in the case where the normal mode is executed, reading/writing with respect to the normal memory area from the inside/outside of the ECU may be available. However, even in the case where the normal mode is executed, access to the secure memory area may be restricted, and thus, the ECU may maintain security.

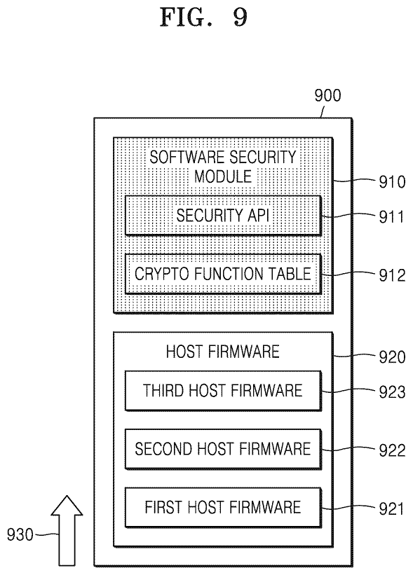

FIG. 9 is an example diagram illustrating a structure of a program memory within an MCU having installed therein a software security module including a crypto function table, according to an embodiment.

Referring to FIG. 9, an MCU (not shown) of an ECU (not shown) within a vehicle may include a program memory 900. In some embodiments, the program memory 900 may refer to the same memory as the program memory 140 of FIGS. 1 and 2.

The program memory 900 may include a software security module 910 and host firmware 920, but is not limited thereto.

The host firmware 920 may refer to core software that is executed for an actual ECU to operate. In some embodiments, the host firmware 920 may include a plurality of pieces of software.

For example, the host firmware 920 may include first host firmware 921, second host firmware 922, and third host firmware 923, but is not limited thereto. In some embodiments, the first host firmware 921 may correspond to an FBL. In some embodiments, the second host firmware 922 and the third host firmware 923 may correspond to different types of ASW.

The software security module 910 may be implemented as firmware separate from the host firmware 920 to include a security API 911 and a crypto function table 912. memory area in which the security API 911 and the crypto function table 912 are located may be set as a secure memory area. The security API 911 may have restricted access from the host firmware 920, but the crypto function table 912 may be accessible from the host firmware 920.

The security API 911, i.e., security function firmware, may refer to software that may execute a security function for protecting the ECU.

For example, the security function that may be executed by the security API 911 may include secure boot, RTP, a secure storage, memory protection, secure debug, cryptographic operations, and random number generation, but is not limited thereto.

The security API 911 may transmit, to the host firmware 920, a result value according to a security function execution request of the host firmware 920.

The crypto function table 912 may refer to software that acts as a bridge to provide a memory address value of the security API 911 to the host firmware 920 so that the host firmware 920 may access the security API 911.

The crypto function table 912 may receive an execution request for a security function from the host firmware 920 and call the memory address value of the security API 911. In some embodiments, the crypto function table 912 may provide the called memory address value of the security API 911 to the host firmware 920. To this end, the software security module 910 and the host firmware 920 may be implemented as firmware compiled as Hex binary files, and thus, security may be enhanced through memory area separation.

In an embodiment, the crypto function table 912 may be implemented in a double pointer structure. In some embodiments, the double pointer structure may refer to a structure that manages an address of a pointer as a pointer. The crypto function table 912 may correspond to a second pointer that stores an address value of a memory for each of security functions included in the security API 911 that is a first pointer. The crypto function table 912 may flexibly modify the address values of the security functions of the security API 911 through the double pointer structure.

In some embodiments, unlike a security API implemented as a library within the host firmware 920, the security API 911 of the software security module 910 implemented as separate firmware from the host firmware 920 does not need to be included in each of a plurality pieces of host firmware, and thus, the use efficiency of resources within the ECU may be high by reducing memory waste.

Although not illustrated in FIG. 9, the program memory 900 may include an SBL (not shown). The SBL may verify integrity of the SBL, the host firmware 920, and the software security module 910 included in the program memory 900 when the MCU is booted.

In some embodiments, the SBL may perform mutual authentication with the software security module 910 to enhance security. In some embodiments, the SBL may perform the mutual authentication by comparing an authentication pattern generated by the SBL with an authentication pattern generated by the software security module 910.

The program memory 900 may execute firmware according to a memory arrangement order 930 in response to receiving a boot signal of the MCU. In an embodiment, the SBL, which is arranged at a start address of the program memory 900, may first operate when the MCU is booted.

The crypto function table 912 may be arranged at the lowest address of the software security module 910, i.e., the start address, and may first operate when the software security module 910 is executed. In some embodiments, the host firmware 920 always needs to go through the crypto function table 912 to obtain a result value by executing a security function, and thus, security may be improved.

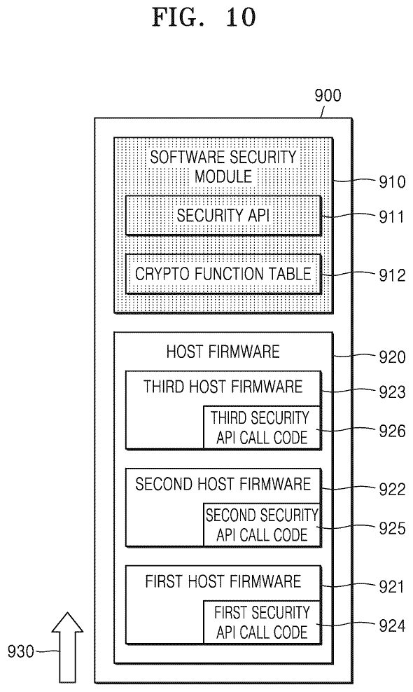

FIG. 10 is an example diagram illustrating a structure of a program memory within an MCU having installed therein host firmware including a security API call code, according to an embodiment.

Referring to FIG. 10, an MCU (not shown) of an ECU (not shown) within a vehicle may include a program memory 900. In some embodiments, the program memory 900 may refer to the same memory as the program memory 140 of FIGS. 1 and 2.

The program memory 900 may include a software security module 910 and host firmware 920, but is not limited thereto.

The host firmware 920 may refer to core software that is executed for an actual ECU to operate. Also, the host firmware 920 may include a plurality of pieces of software.

For example, the host firmware 920 may include first host firmware 921, second host firmware 922, and third host firmware 923, but is not limited thereto. In some embodiments, the first host firmware 921 may correspond to an FBL. In some embodiments, the second host firmware 922 and the third host firmware 923 may correspond to different types of ASW.

Each of the first host firmware 921, the second host firmware 922, and the third host firmware 923 may respectively include a first security API call code 924, a second security API call code 925, and a third security API call code 926. The first security API call code 924, the second security API call code 925, and the third security API call code 926 may refer to pre-stored codes used to call a security API 911, and may transmit an execution request for a security function to a crypto function table 912.

In some embodiments, the first security API call code 924, the second security API call code 925, and the third security API call code 926 may only codes that provide respective methods for the first host firmware 921, the second host firmware 922, and the third host firmware 923 to access the crypto function table 912, and host firmware that does not include the first security API call code 924, the second security API call code 925, and the third security API call code 926 may not access the crypto function table 912. In an embodiment, the first security API call code 924, the second security API call code 925, and the third security API call code 926 may be referred to as function table gateways.

The software security module 910 may be implemented as separate firmware from the host firmware 920 and may include the security API 911 and the crypto function table 912. The security API 911 and the crypto function table 912 may be set as secure memory areas, and access thereto may be restricted.

The security API 911 may refer to software that may execute a security function for protecting the ECU. In some embodiments, the crypto function table 912 may refer to software that acts as a bridge to provide a memory address value of the security API 911 to the host firmware 920 so that the host firmware 920 may access the security API 911.

The program memory 900 may execute firmware according to a memory arrangement order 930 in response to receiving a boot signal of the MCU.

For example, the crypto function table 912 may be arranged at the lowest address of the software security module 910, i.e., a start address, and may first operate when the software security module 910 is executed.

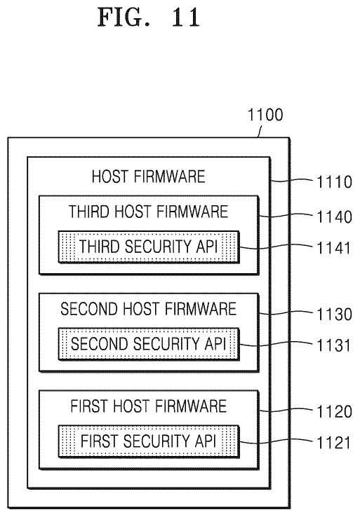

FIG. 11 is an example diagram illustrating a structure of a program memory within an MCU in which a security API is implemented in a library form within host firmware, according to an embodiment.

Referring to FIG. 11, a program memory 1100 included in an MCU (not shown) of an ECU (not shown) within a vehicle (not shown) may include host firmware 1110. In some embodiments, the program memory 1100 may refer to the same memory as the program memory 140 of FIGS. 1 and 2.

The host firmware 1110 may refer to core software executed for an actual ECU to operate, and may include a plurality of pieces of software.

For example, the host firmware 1110 may include first host firmware 1120, second host firmware 1130, and third host firmware 1140, but is not limited thereto. In some embodiments, the first host firmware 1120 may correspond to an FBL. In some embodiments, the second host firmware 1130 and the third host firmware 1140 may correspond to different types of ASW.

In some embodiments, the first host firmware 1120, the second host firmware 1130, and the third host firmware 1140 may respectively include a first security API 1121, a second security API 1131, and a third security API 1141 implemented in library forms, i.e., may include security function libraries.

For example, the first security API 112, the second security API 1131, and the third security 1141 may be statically linked to the first host firmware 1120, the second host firmware 1130, and the third host firmware 1140, respectively, and compiled.

In some embodiments, each of the first security API 1121, the second security API 1131, and the third security API 1141 may refer to software that may execute a security function for protecting an ECU.

For example, the security function, which may be executed by each of the first security API 1121, the second security API 1131, and the third security API 1141, may include secure boot, RTP, a secure storage, memory protection, secure debug, cryptographic operations, and random number generation, but is not limited thereto.

The first security API 1121, the second security API 1131, and the third security API 1141 may be compiled in library forms only within the first host firmware 1120, the second host firmware 1130, and the third host firmware 1140 that need security functions, and a security API may not be compiled in host firmware that does not need a security function.

The first security API 1121, the second security API 1131, and the third security API 1141 may derive result values by executing the security functions requested by the first host firmware 1120, the second host firmware 1130, and the third host firmware 1140. The derived result values may be transmitted to the first host firmware 1120, the second host firmware 1130, and the third host firmware 1140, respectively, through the first security API 1121, the second security API 1131, and the third security API 1141.

However, all of the first security API 1121, the second security API 1131, and the third security API 1141, which are compiled in the library forms, need to be compiled in the first host firmware 1120, the second host firmware 1130, and the third host firmware 1140 that need the security functions, and thus, a memory area may be repeatedly used. For example, in the case where 45 kb of memory resources are used for each of the first security API 1121, the second security API 1131, and the third security API 1141, the total memory resources used for the security functions may be 135 kb. In contrast, according to the embodiments of FIGS. 9 and 10, the security API 911 may be present within the software security module 910 having the firmware form, and the memory resources used for the security functions may be 64 kb, which are memory resources used by the software security module 910. In some embodiments, according to the embodiments of FIGS. 9 and 10 in which the software security module 910 is implemented in the firmware form, fewer memory resources may be used than in the embodiment of FIG. 11 in which a software security module is implemented in a library form.

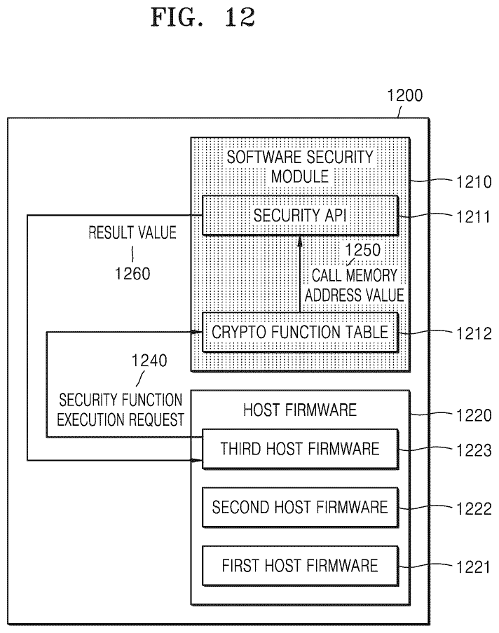

FIG. 12 is an example diagram illustrating a method of providing a result value in response to a security function execution request of host firmware, according to an embodiment.

Referring to FIG. 12, an MCU (not shown) of an ECU (not shown) within a vehicle may include a program memory 1200. In some embodiments, the program memory 1200 may refer to the same memory as the program memory 140 of FIGS. 1 and 2.

The program memory 1200 may include a software security module 1210 and host firmware 1220, but is not limited thereto.

The host firmware 1220 may refer to core software that is executed for an actual ECU to operate. In some embodiments, the host firmware 1220 may include a plurality of pieces of software (i.e., first host firmware 1221, second host firmware 1222, and third host firmware 1223).

The software security module 1210 may be implemented as separate firmware from the host firmware 1220, and may include a security API 1211 and a crypto function table 1212. The security API 1211 and the crypto function table 1212 may be set as secure memory areas, and access thereto may be restricted.

The host firmware 1220 may transmit a security function execution request 1240 to the software security module 1210. In some embodiments, the host firmware 1220 may transmit the security function execution request 1240 to the crypto function table 1212 of the software security module 1210.

In some embodiments, the crypto function table 1212, which receives the security function execution request 1240, may call a memory address value of the security API 1211 1250.

In some embodiments, the security API 1211 may derive a result value 1260 by executing a security function requested by the host firmware 1220.

In some embodiments, the security API 1211 may transmit the derived result value 1260 to the host firmware 1220.

In an embodiment, the third host firmware 1223 may transmit the security function execution request 1240 to the crypto function table 1212. In some embodiments, the crypto function table 1212, which receives the security function execution request 1240, may call the memory address value of the security API 1211 1250. In some embodiments, the security API 1211 may derive the result value 1260 by executing the security function requested by the third host firmware 1223. In some embodiments, the security API 1211 may transmit the derived result value 1260 to the third host firmware 1223.

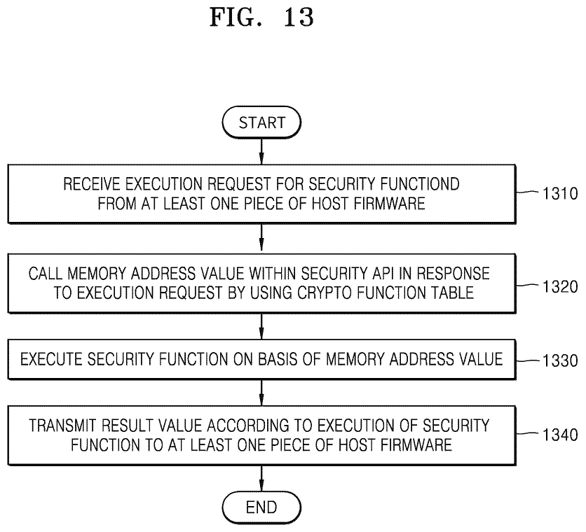

FIG. 13 is a flowchart illustrating a method of executing a security function by using a software security module including a crypto function table, according to an embodiment.

Referring to FIG. 13, the method of executing the security function by using the software security module including the crypto function table may include operations processed in a time series in the program memory 140 illustrated in FIGS. 1 and 2. Therefore, even in the case where the above description of the program memory 140 illustrated in FIGS. 1 and 2 is omitted, the above description may also be applied to the method of executing the security function by using the software security module including the crypto function table, illustrated in FIG. 13.

In operation 1310, a software security module within a program memory may receive an execution request for a security function from at least one piece of host firmware.

For example, the host firmware may transmit the execution request for the security function to a crypto function table by using a security API call code that is pre-stored in the host firmware.

In operation 1320, the software security module within the program memory may call a memory address value of a security API according to the execution request for the security function by using the crypto function table.

For example, the crypto function table may store the memory address value of the security API. In some embodiments, the crypto function table may call the stored memory address value of the security API by receiving the execution request for the security function from the host firmware.

In operation 1330, the software security module within the program memory may execute a security function on the basis of the memory address value.

For example, the security API may execute the security function corresponding to the memory address value called by the crypto function table.

In operation 1340, a result value according to the execution of the security function may be transmitted to at least one piece of host firmware.

For example, the security API may derive a result value according to the execution of the security function requested by the host firmware and transmit the derived result value to the host firmware that requests the execution of the security function.

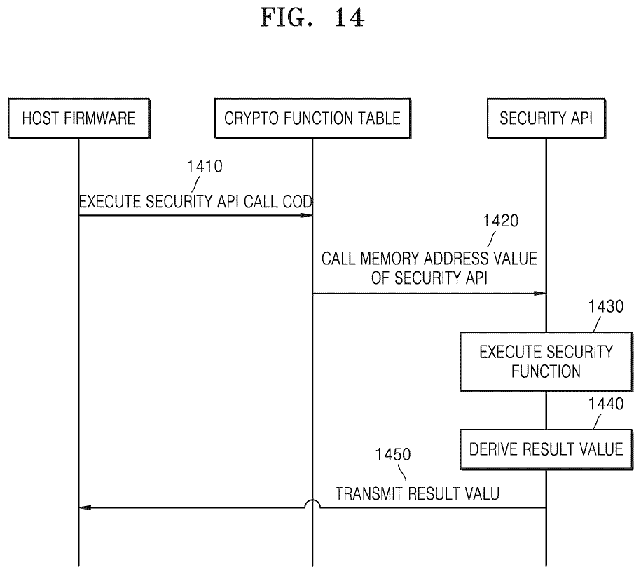

FIG. 14 is a flowchart illustrating a method by which a software security module provides a result value in response to a security function execution request of host firmware, according to an embodiment.

Referring to FIG. 14, the method by which the software security module provides the result value in response to the security function execution request of the host firmware may include operations processed in a time series in the program memory 140 illustrated in FIGS. 1 and 2. Therefore, even in the case where the above description of the program memory 140 illustrated in FIGS. 1 and 2 is omitted, the above description may also be applied to the method by which the software security module provides the result value in response to the security function execution request of the host firmware.

In operation 1410, host firmware may execute a security API call code that is pre-stored in the host firmware.

The host firmware may execute the security API call code to transmit an execution request for at least one security function to a crypto function table.

In operation 1420, the crypto function table may call a memory address value of a security API.

For example, the crypto function table may be implemented as a double pointer structure to store memory address values for respective security functions included in the security API. In some embodiments, the crypto function table may call the stored memory address value of the security API in response to the security function execution request of the host firmware and provide the called memory address value to the host firmware.

In operation 1430, the security API may execute a security function.

For example, the security API may execute the corresponding security function when the memory address value of the security function requested by the host firmware is called.

In operation 1440, the security API may derive a result value according to the execution of the security function.

In operation 1450, the security API may transmit the result value according to the execution of the security function to the host firmware.

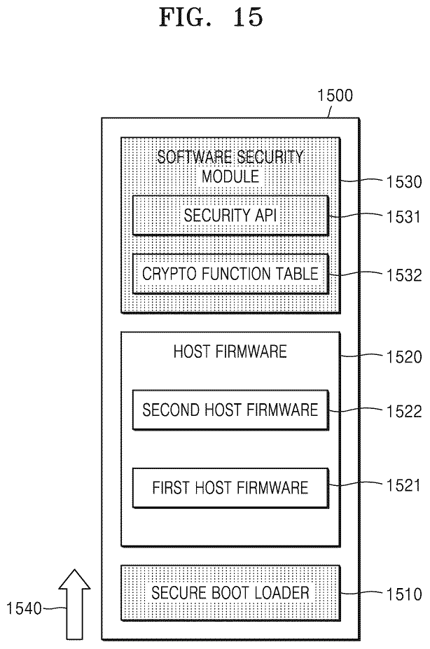

FIG. 15 is an example diagram illustrating a structure of a program memory within an MCU including a software security module, which is implemented in a firmware form and includes a security API, and an SBL, according to an embodiment.

Referring to FIG. 15, an MCU (not shown) of an ECU (not shown) within a vehicle may include a program memory 1500. Here, the program memory 1500 may refer to the same memory as the program memory 140 of FIGS. 1 and 2.

The program memory 1500 may include an SBL 1510, host firmware 1520, and a software security module 1530, but is not limited thereto.

The SBL 1510 may verify integrity of the SBL 1510, the host firmware 1520, and the software security module 1530 included in the program memory 1500 when an MCU is booted.

In some embodiments, the SBL 1510 may perform mutual authentication with the software security module 1530 to enhance security. In some embodiments, the SBL 1510 may perform the mutual authentication by comparing an authentication pattern generated by the SBL 1510 with an authentication pattern generated by the software security module 1530.

The program memory 1500 may execute firmware according to a memory arrangement order 1540 in response to receiving a boot signal of the MCU. For example, the SBL 1510 may be arranged at a start address of the program memory 1500 to first operate in response to the MCU receiving the boot signal.

The host firmware 1520 may refer to core software executed for an actual ECU to operate. In some embodiments, the host firmware 1520 may include a plurality of pieces of software.

For example, the host firmware 1520 may include first host firmware 1521 and second host firmware 1522, but is not limited thereto. In some embodiments, the first host firmware 1521 may correspond to an FBL. In some embodiments, the second host firmware 1522 may correspond to ASW.

The software security module 1530 may refer to software that may perform a security function for protecting the ECU.

For example, the security function may include secure boot, RTP, a secure storage, memory protection, secure debug, cryptographic operations, and random number generation, but is not limited thereto.

In some embodiments, the software security module 1530 may improve security of the ECU through the mutual authentication. In some embodiments, the software security module 1530 may receive an instruction for generating an authentication pattern from the SBL 1510 and generate an authentication pattern by using an authentication number included in the SBL 1510. The software security module 1530 may also perform the mutual authentication on the basis of generating the authentication pattern, comparing the authentication pattern generated by the software security module 1530 with an authentication pattern generated by the SBL 1510, and determining whether or not the authentication patterns are the same as each other.

In some embodiments, the software security module 1530 may be arranged at an end address of the program memory 1500.

In some embodiments, the software security module 1530 may include a security API 1531 and a crypto function table 1532. A memory area in which the security API 1531 and the crypto function table 1532 are located may be set as a secure memory area. The security API 1531 may have restricted access from the host firmware 1520, but the crypto function table 1532 may be accessed from the host firmware 1520.

The security API 1531, i.e., security function firmware, may refer to software that may execute a security function for protecting the ECU.

For example, the security function that may be executed by the security API 1531 may include secure boot, RTP, a secure storage, memory protection, secure debug, cryptographic operations, and random number generation, but is not limited thereto.

The security API 1531 may transmit, to the host firmware, a result value according to a security function execution request of the host firmware.

The crypto function table 1532 may refer to software that acts as a bridge to provide a memory address value of the security API 1531 to the host firmware 1520 so that the host firmware 1520 may access the security API 1531.

The crypto function table 1532 may receive an execution request for a security function from the host firmware 1520 and call the memory address value of the security API 1531. In some embodiments, the crypto function table 1532 may provide the called memory address value of the security API 1531 to the host firmware 1520. To this end, the software security module 1530 and the host firmware 1520 may be implemented as firmware compiled as Hex binary files, and thus, security may be enhanced through memory area separation.

Unlike a security API implemented in a library form within the host firmware 1520, the security API 1531 of the software security module 1530 implemented as separate firmware from the host firmware 1520 does not need to be included in each of a plurality of pieces of host firmware, and thus, the use efficiency of resources within the ECU may be high by reducing memory waste.

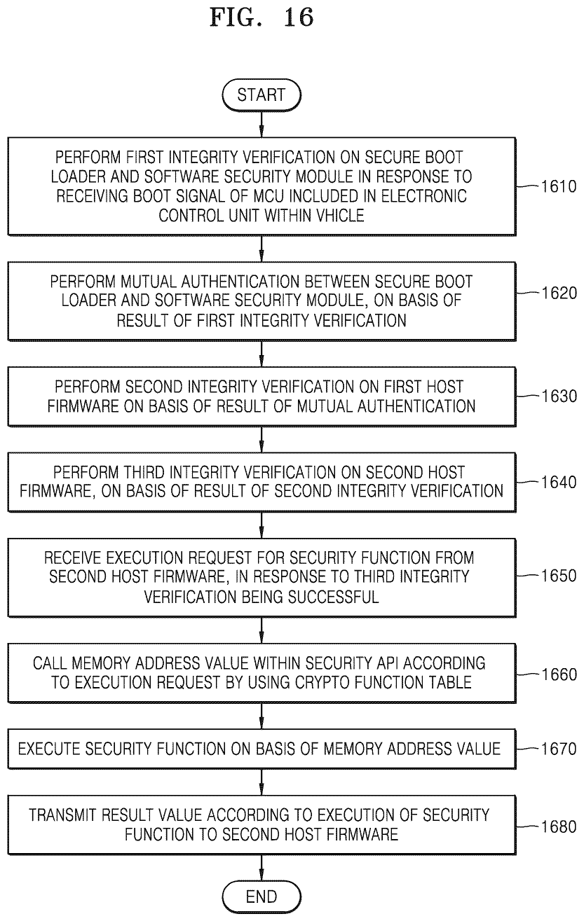

FIG. 16 is a flowchart illustrating a method of booting an ECU through mutual authentication and executing a security function by using a software security module including a crypto function table, according to one embodiment.

Referring to FIG. 16, the method of booting the ECU through the mutual authentication and executing the security function by using the software security module including the crypto function table may include operations processed in a time series in the program memory 140 illustrated in FIGS. 1 and 2. Therefore, even in the case where the above description of the program memory 140 illustrated in FIGS. 1 and 2 is omitted, the above description may also be applied to the method of booting the ECU through the mutual authentication and executing the security function by using the software security module including the crypto function table.

In operation 1610, an SBL within a program memory may perform first integrity verification on the SBL and a software security module in response to receiving a boot signal of an MCU included in an ECU within a vehicle.

For example, the SBL may first perform 1^{st}-1 integrity verification on the SBL after receiving the boot signal of the MCU.

In some embodiments, the SBL may perform 1^{st}-2 integrity verification on the software security module on the basis of the result of the 1^{st}-1 integrity verification. In some embodiments, in the case where the 1^{st-}1 integrity verification is successful, the SBL may perform the 1^{st}-2 integrity verification on the software security module.

In operation 1620, the SBL within the program memory may perform mutual authentication between the SBL and the software security module, on the basis of the result of the first integrity verification.

For example, in the case where both the 1^{st}-1 integrity verification on the SBL and the 1^{st}-2 integrity verification on the software security module are successful, the SBL may perform the mutual authentication between the SBL and the software security module.

In operation 1630, the SBL within the program memory may perform second integrity verification on first host firmware on the basis of the result of the mutual authentication.

In some embodiments, the first host firmware may refer to an FBL.

For example, in the case where a first authentication pattern generated by the SBL matches a second authentication pattern generated by the software security module, the SBL may determine that the mutual authentication is successful and perform the second integrity verification on the first host firmware.

Accordingly, the MCU may provide RoT, i.e., a highest security trust point.

In operation 1640, the SBL within the program memory may perform third integrity verification on second host firmware, on the basis of the result of the second integrity verification.

In some embodiments, the first host firmware may determine whether or not integrity verification on the second host firmware is successful.

In operation 1650, the software security module within the program memory may receive an execution request for a security function from the second host firmware in response to the third integrity verification being successful.

For example, the second host firmware may transmit the execution request for the security function to a crypto function table by using a security API call code that is pre-stored in the second host firmware.

In operation 1660, the software security module within the program memory may call a memory address value within a security API according to the execution request by using the crypto function table.

For example, the crypto function table may store the memory address value of the security API. In some embodiments, the crypto function table may call the stored memory address value of the security API by receiving the execution request for the security function from the second host firmware.

In operation 1670, the software security module within the program memory may execute the security function on the basis of the memory address value.

For example, the security API may execute the security function corresponding to the memory address value called by the crypto function table.

In operation 1680, the software security module within the program memory may transmit, to the second host firmware, a result value according to the execution of the security function.

For example, the security API may derive a result value according to the execution of the security function requested by the host firmware and transmit the derived result value to the host firmware that requests the execution of the security function.

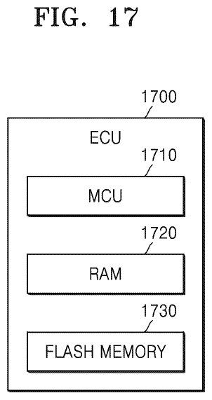

FIG. 17 is an example diagram illustrating a structure of an ECU within a vehicle, according to an embodiment.

Referring to FIG. 17, an ECU 1700 may include an MCU 1710, RAM 1720, and flash memory 1730.

The MCU 1710 may perform a logical operation needed for the ECU 1700 to perform a role. In some embodiments, the MCU 1710 may include a CPU, RAM, P-flash (program memory), and D-flash (data memory). A program memory within the MCU 1710 may include an SBL, host firmware, and a software security module. The SBL may perform integrity verification on the SBL, the host firmware, and the software security module and perform mutual authentication between the SBL and the software security module. In some embodiments, the software security module may perform a security function for protecting the ECU, such as secure boot, secure storage, or secure debug.

The RAM 1720 may refer to a volatile memory used by the ECU to process and store data in real time, and may quickly store and process sensor data that is input from various components of the vehicle such as an engine, a transmission, and a brake. In some embodiments, the RAM 1720 may correspond to SRAM, DRAM, FRAM, or the like, but is not limited thereto.

The flash memory 1730 may refer to a non-volatile memory that retains data even in the case where power is turned off, and may store software for controlling an operation of the ECU, i.e., a program code. In some embodiments, the flash memory 1730 may update the stored software in a method such as over the air (OTA). In some embodiments, the flash memory 1730 may store an error record and the like that occurs while the vehicle travels.

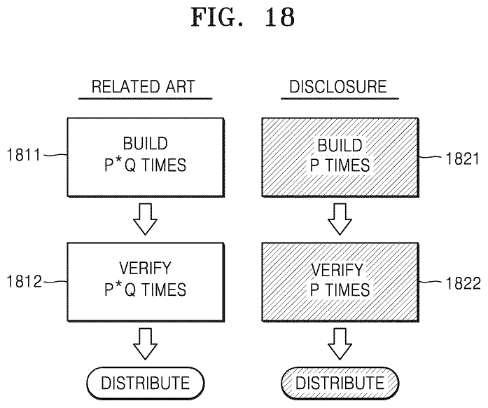

FIG. 18 is an example view illustrating a method of building and verifying a software security module, according to an embodiment.

FIG. 18 illustrates that a method for building 1811 and verifying 1812 according to the related art in the case where a type of semiconductor or a type of compiler is changed, and a method for building 1821 and verifying 1822 according to the disclosure. In some embodiments, the change in the type of compiler may include changes in a version and an option, but is not limited thereto.

In operation 1811, according to the related art, a software security module needs additional build according to the change in the type of semiconductor or the type of compiler.

For example, in the case where P types of semiconductor and Q types of compilers are present within an ECU, a solution manufacturer needs to perform build P×Q times for distribution of a software security solution.

In operation 1812, verification needs to be performed on each of built software security modules.

For example, in the case where build is performed P×Q times, verification may be performed P×Q times accordingly.

In contrast, in operation 1821, according to the disclosure, a software security module may be implemented in an execution binary form, and thus, additional build according to a change in a type of the compiler may not be needed.

For example, in the case where P types of semiconductor and Q types of compilers are present within an ECU, a solution manufacturer may perform build only P times for distribution of a software security module. In some embodiments, the number of times of build does not increase despite the increase in the types of compilers caused by the change in the type of compiler.

In operation 1822, verification may be performed on each of built software security modules.

For example, in the case where build is performed a total of P times, verifications may be performed P times accordingly.

In some embodiments, according to the disclosure, the number of times of verification may also decrease with a decrease in the number of times of build for the software security module. In some embodiments, the number of times of verification may not increase despite the increase in the types of compilers caused by the change in the type of compiler.

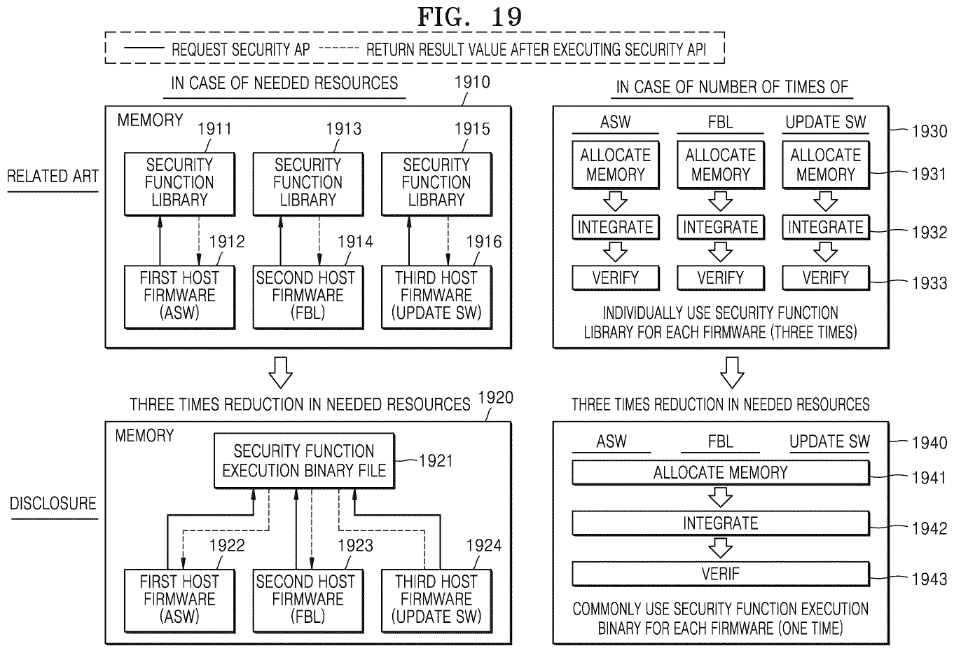

FIG. 19 is an example view illustrating a structure in which a software security module provides a result value in response to a security function execution request of host firmware, according to an embodiment.

Referring to FIG. 19, upper blocks 1910 and 1930 illustrate components according to the related art, and lower blocks 1920 and 1940 illustrate components according to the disclosure. In some embodiments, a program memory 1910 may refer to the same memory as the program memory 140 of FIGS. 1 and 2.

In the case of the number of memory resources needed, according to the related art, first host firmware 1912, second host firmware 1914, and third host firmware 1916 may request security function libraries 1911, 1913, and 1915 implemented within respective pieces of host firmware, i.e., software security modules implemented in library forms, to execute a security function. The security function libraries 1911, 1913, and 1915 may call a memory address value of a security API according to a security function execution request by using a crypto function table. The security function libraries 1911, 1913, and 1915 may execute the security function on the basis of the corresponding memory address value. The result of the execution of the security function may be transmitted to each of the first host firmware 1912, the second host firmware 1914, and the third host firmware 1916.

In contrast, in an embodiment according to the disclosure, in the case where a software security module is implemented as one security function execution binary file 1921 regardless of the number of pieces of host firmware, first host firmware 1922, second host firmware 1923, and third host firmware 1924 may request a common software security module to execute a security function. The security function execution binary file 1921 may call a memory address value of a security API according to a security function execution request by using a crypto function table. The security function execution binary file 1921 may execute the security function on the basis of the corresponding memory address value. The result of executing the security function may be transmitted to each of pieces of host firmware.

For example, as illustrated in FIG. 19, in the case where three pieces of host firmware (e.g., the first host firmware 1922, the second host firmware 1923, and the third host firmware 1924) are present, software security modules may not be implemented as the separate security function libraries 1911, 1913, and 1915 within the first host firmware 1922, the second host firmware 1923, and the third host firmware 1924, and in the case where the software security module is implemented as the security function execution library 1921, the number of memory resources needed may be reduced to one-third compared to the related art.

In the case of the number of times of integration and verification, according to the related art, memories need to be individually allocated 1931 to the security function libraries 1911, 1913, and 1915, respectively, within respective pieces of host firmware (AWS, FBL, and update SW), integrated 1932, and verified 1933.

In contrast, in an embodiment according to the disclosure, in the case where the software security module is built as an execution binary type as separate firmware from the host firmware, the security function execution binary file 1921 may be allocated only once 1931, integrated 1932, and verified 1933.

For example, as illustrated in FIG. 19, in the case where three pieces of host firmware (e.g., the first host firmware 1922, the second host firmware 1923, and the third host firmware 1924) are present, the number of times of integration and verification may be reduced to one-third compared to the related art.

Therefore, as illustrated in FIG. 19, according to the disclosure, the amount of memory needed may be reduced and simultaneously, the number of times of integration and verification procedure may be reduced through implementation of an execution binary-based software security module.

According to the problem solving means of the disclosure described above, in the disclosure, when booting a micro-controller unit (MCU) included in an electronic control unit (ECU) of a vehicle, integrity of at least one piece of host firmware included in the MCU may be corrected to prevent tampering and threats to the host firmware.

In the present disclosure, flexibility and security of the MCU may be improved by using a software security module without using a security module implemented with hardware.

In the disclosure, security may be improved by restricting access to a secure memory area from the outside by setting a secure memory area within the MCU.

In the disclosure, an abnormal operation of the ECU unit may be fundamentally blocked through mutual authentication between a secure boot loader and a software security module by using an authentication number within the secure boot loader.

In the disclosure, efficiency of resource use may be improved by preventing a security API from being redundantly installed in the MCU of the ECU.

In the disclosure, stability and compatibility may be improved through the security API that is not affected by a build option of the host firmware.

In the disclosure, security may be improved by limiting an entry point for a security function request of the host firmware to a crypto function table.

The effects of the embodiments are not limited to the effects mentioned above, and other effects not mentioned may be clearly understood by those skilled in the art from the description of the disclosure.

Embodiments according to the disclosure may be implemented in the form of a computer program that may be executed through various components on a computer, and the computer program may be recorded on a computer-readable medium. Here, the medium may include magnetic media, such as a hard disk, a floppy disk, and a magnetic tape, optical recording media, such as CD-ROM and DVD, a magneto-optical medium, such as a floptical disk, and hardware devices, such as ROM, RAM, and flash memory specially configured to store and execute program instructions.

Meanwhile, the computer program may be specially designed and configured for the disclosure, or may be known to and used by those skilled in the art of the computer software field. Examples of the computer program may include not only machine language code generated by a compiler but also high-level language code that may be executed by a computer by using an interpreter or the like.

According to an embodiment, the method according to various embodiments may be included and provided in computer program products. The computer program products may be traded between sellers and buyers as commodities. The computer program products may be distributed in the form of device-readable storage media (e.g., compact disc read only memory (CD-ROM)), or may be distributed (e.g., downloaded or uploaded) online via an application store (e.g., Play Store™) or directly between two user devices. When distributed online, at least a portion of a computer program product may be temporarily stored or temporarily generated in a device-readable storage medium such as a server of a manufacturer, a server of an application store, or a memory of a relay server.

The operations constituting the method according to the disclosure may be performed in any appropriate order unless an order of the operations is explicitly stated or stated to the contrary. The disclosure is not necessarily limited according to the order of description of the operations. The use of all examples or example terms (e.g., and the like) in the disclosure is simply to describe the disclosure in detail, and the scope of the disclosure is limited due to the examples or example terms unless limited by claims. In addition, those skilled in the art may appreciate that various modifications, combinations, and changes may be made according to design conditions and factors within the scope of appended claims or equivalents thereof.

Therefore, the spirit of the disclosure should not be limited to the above-described embodiments, and not only claims described below, but also all scopes equivalent to the claims or equivalently changed therefrom will fall within the spirit of the disclosure.

What is claimed is:

1. A method for secure booting of an electronic control unit through mutual authentication, the method comprising:
performing first integrity verification on a secure boot loader and a software security module in response to receiving a boot signal of a micro-controller unit (MCU) included in an electronic control unit within a vehicle;
performing mutual authentication between the secure boot loader and the software security module, on the basis of a result of the first integrity verification; and
performing second integrity verification on first host firmware on the basis of a result of the mutual authentication above.

2. The method of claim 1, wherein the performing the mutual authentication comprises:
generating a first authentication pattern by using the secure boot loader;
generating a second authentication pattern by using the software security module; and
performing the mutual authentication by comparing the first authentication pattern and the second authentication pattern.

3. The method of claim 2, wherein the generating the first authentication pattern and the second authentication pattern comprises generating the first authentication pattern and the second authentication pattern by using an authentication number included in the secure boot loader.

4. The method of claim 2, wherein the method further comprises, in a case where the first authentication pattern and the second authentication pattern are not equal to each other, determining that the mutual authentication fails and rebooting the secure boot loader or restricting execution of the software security module.

5. The method of claim 1, wherein the method further comprises executing a protection mode restricting access to a secure memory area within the MCU, in response to receiving the boot signal, wherein the secure memory area comprises at least one of the secure boot loader, the software security module, and a partial area of read only memory (RAM), data memory, and program memory used by the software security module.

6. The method of claim 5, wherein the method further comprises switching from the protection mode to a normal mode in response to the second integrity verification being successful.

7. The method of claim 1, wherein the performing the first integrity verification comprises:
performing 1^{st}-1 integrity verification which is self-integrity verification on the secure boot loader; and
performing 1^{st}-2 integrity verification on the software security module on the basis of a result of the self-integrity verification.

8. The method of claim 1, wherein the method further comprises performing third integrity verification on second host firmware on the basis of a result of the second integrity verification.

9. The method of claim 1, wherein the software security module comprises security function firmware implemented as separate firmware from the first host firmware and the secure boot loader within the program memory within the MCU.

10. The method of claim 1, wherein the secure boot loader comprises
firmware arranged at a start address when the program memory within the MCU is booted.

11. A program memory within a vehicle, the program memory comprising:
a secure boot loader;
a software security module; and
at least one piece of host firmware, wherein the secure boot loader performs first integrity verification on the secure boot loader and the software security module in response to receiving a boot signal of the MCU, performs mutual authentication between the secure boot loader and the software security module on the basis of a result of the first integrity verification, and performs second integrity verification on first host firmware on the basis of a result of the mutual authentication.
